(19) United States
(12) Patent Application Publication
(10) Pub. No.: US 2026/0025672 A1
(43) Pub. Date: Jan. 22, 2026

(54) WIRELESS CONNECTING DEVICE AND METHOD FOR SWITCHING A NETWORK IN A REDUNDANT ENVIRONMENT

(71) Applicants: HYUNDAI MOTOR COMPANY, Seoul (KR); KIA CORPORATION, Seoul (KR); KANAVI MOBILITY CO.,LTD., Incheon (KR)

(72) Inventors: Jin-Seok Kim, Hwaseong-si (KR); Sung-Huy Kim, Hwaseong-si (KR); Jae-Hong Shin, Hwaseong-si (KR); Il-Do Jung, Hwaseong-si (KR); Ji-Hoon Park, Hwaseong-si (KR); Cheol-Min Kim, Hwaseong-si (KR); Yeon-Jun Park, Yongin-si (KR); Jeong-Kil Lee, Suwon-si (KR); Jong-Taek Chong, Incheon (KR)

(73) Assignees: HYUNDAI MOTOR COMPANY, Seoul (KR); KIA CORPORATION, Seoul (KR); KANAVI MOBILITY CO.,LTD., Incheon (KR)

(21) Appl. No.: 18/961,102

(22) Filed: Nov. 26, 2024

(30) Foreign Application Priority Data
Jul. 16, 2024 (KR) 10-2024-0093841

(51) Int. Cl. H04W 24/02

(52) U.S. Cl. CPC H04W 24/02

(57) ABSTRACT

A wireless connecting device is provided for minimizing non-operation due to communication disconnection and/or delay of wireless equipment in a production factory environment. The wireless connecting device includes a connection unit communicatively connected to wireless equipment in a wired manner. The device further includes a control unit configured to execute, as main communication, a first communication mode in which the wireless equipment is connected to one of two network blocks, which are in the redundant environment; check whether a communication failure occurs during the execution of the first communication mode; and when the communication failure occurs, execute a second communication mode in which the wireless equipment is connected to the other of the two network blocks. The device further includes a communication circuit configured to connect the wireless equipment to one of the two network blocks according to the first communication mode or the second communication mode.

### CROSS-REFERENCE TO RELATED APPLICATION

This application claims priority to Korean Patent Application No. 10-2024-0093841, filed on Jul. 16, 2024, the entire contents of which are incorporated herein by reference.

### TECHNICAL FIELD

The present disclosure relates to a network switching technology and more particularly relates to a wireless connecting device and a wireless connecting method for supporting rapid network switching in a wireless network redundant environment.

### BACKGROUND

Currently, industrial commercial terminals that support heterogeneous wireless communication can selectively use only one of wireless fidelity (Wi-Fi) or Private-5G (P-5G) connections.

In this case, when a problem occurs in the selected communication method, switching to another communication method is not performed, resulting in non-operation. Therefore, the automatic switching of the communication network is required when a problem occurs. Generally, the occurrence of a problem is determined by a sensitivity state of a wireless signal.

In addition, in the case of a communication method switching technology based on wireless signal sensitivity, such as a mobile phone, when a situation just before a thresholder in which a communication method should be switched becomes prolonged, mission-critical equipment such as an automated guided vehicle (AGV) may not be operated due to communication delay.

In other words, when accurate handover parameters are not applied to a wireless usage location, frequent switching between 4G, 5G, and Wi-Fi occurs. In this case, factors causing the production plant to be out of operation due to poor communication quality increase. Thus, there is a disadvantage that it is difficult to manage handover parameters.

In addition, in the case of communication disconnection problems caused by problems with core equipment rather than problems with base station (wireless signals are normal), a communication failure cannot be determined using wireless signal sensitivity. Therefore, clear communication failure determination is needed.

In particular, because a connection is attempted to a heterogeneous network that requires a connection process from a physical layer to an application layer in the event of a failure situation, a delay time inevitably occurs due to performing the connection process. The subject matter described in this background section is intended to promote an understanding of the background of the disclosure and thus may include subject matter that is not already known to those of ordinary skill in the art.

### SUMMARY OF THE DISCLOSURE

The present disclosure has been proposed to solve the above problems and is directed to providing a wireless connecting device and a wireless connecting device method, which are capable of minimizing a non-operation due to communication disconnection and/or delay of wireless equipment in a production factory environment in which non-operation should not occur, such as a smart factory.

In addition, the present disclosure is directed to providing a wireless connecting device and a wireless connecting device method, which may minimize the non-operation of production equipment due to a communication problem using both Wi-Fi and P-5G.

A wireless connecting device is provided for minimizing non-operation due to communication disconnection and/or delay of wireless equipment in a production factory environment in which non-operation should not occur, such as a smart factory.

According to one aspect of the present disclosure, a wireless connecting device includes a connection unit communicatively connected to wireless equipment in a wired manner. The device further includes a control unit configured to execute a first communication mode as main communication. In the first communication mode, the wireless equipment is connected to one of two network blocks. The two network blocks are in the redundant environment. The control unit is further configured to check whether a communication failure occurs during the execution of the first communication mode. The control unit is further configured, when the communication failure occurs, to execute a second communication mode. In the second communication mode, the wireless equipment is connected to the other of the two network blocks. The device further includes a communication circuit configured to connect the wireless equipment to one of the two network blocks according to the first communication mode or the second communication mode.

The control unit includes a check module configured to calculate a first delay time according to a ping test toward the two network blocks. The control unit further includes a determination module configured to compare the first delay time with a preset threshold time and determine whether a communication failure occurs according to the result of the comparison. The control unit further includes a mode execution module configured to execute the second communication mode when it is determined that the communication failure has occurred according to the result of the determination.

The mode execution module holds the execution of the first communication mode when it is determined that the communication failure has not occurred according to the result of the determination.

After the second communication mode is executed, the check module calculates a second delay time according to the ping test toward one of the two network blocks. The determination module compares the second delay time with the preset threshold time. The determination module determines whether the communication failure occurs according to the result of the comparison. When it is determined that the communication failure has occurred according to the result of the determination, the determination module determines whether a non-recurrence condition that defines that the communication failure does not recur is satisfied. When the non-recurrence condition is satisfied, the mode execution module returns to the first communication mode.

The non-recurrence condition is a condition in which the second delay time is continuously shorter than or equal to the preset threshold time for a specific time.

When the non-recurrence condition is not satisfied, the mode execution module holds the execution of the second communication mode.

The control unit simultaneously accesses the two network blocks during booting.

The two network blocks are heterogeneous communication networks.

The heterogeneous communication networks include a Wi-Fi communication network and a Private-5G (P-5G) communication network.

According to another aspect of the present disclosure, a method of switching a network in a redundant environment includes communicatively connecting wireless equipment to a connection unit in a wired manner. The method further includes executing, by a control unit, a first communication mode as main communication. In the first communication mode, the wireless equipment is connected to one of two network blocks. The two network blocks are in a redundant environment. The method further includes checking, by the control unit, whether a communication failure occurs during the execution of the first communication mode. The method further includes when the communication failure occurs, executing, by the control unit, a second communication mode. In the second communication mode, the wireless equipment is connected to the other of the two network blocks. The method further includes connecting, by a communication circuit, the wireless equipment to one of the two network blocks according to the first communication mode or the second communication mode.

Executing the second communication mode includes calculating, by a check module, a first delay time according to a ping test toward the two network blocks. Executing the second communication mode further includes comparing, by a determination module, the first delay time with a preset threshold time. Executing the second communication mode further includes determining, by the determination module, whether a communication failure occurs according to a result of the comparison. Executing the second communication mode further includes executing, by a mode execution module, rebooting when it is determined that the communication failure has occurred according to a result of the determination.

Executing the second communication mode includes holding, by the mode execution module, the execution of the first communication mode when it is determined that the communication failure has not occurred according to the result of the determination.

Executing the second communication mode includes, after the second communication mode is executed, calculating, by the check module, a second delay time according to the ping test toward one of the two network blocks. Executing the second communication mode further includes comparing, by the determination module, the second delay time with the preset threshold time. Executing the second communication mode further includes determining, by the determination module, whether the communication failure occurs according to the result of the comparison. Executing the second communication mode further includes when it is determined that the communication failure has occurred according to the result of the determination, determining, by the determination module, whether a non-recurrence condition that defines that the communication failure does not recur is satisfied. Executing the second communication mode further includes when the non-recurrence condition is satisfied, returning, by the mode execution module, to the first communication mode.

Returning to the first communication mode includes, when the non-recurrence condition is not satisfied, holding, by the mode execution module, the execution of the second communication mode.

Returning to the first communication mode includes setting a metric that specifies the first communication mode to have a higher priority than the second communication mode. Returning to the first communication mode further includes re-setting system settings required while operating in the second communication mode to be used after switching to the second communication mode.

Returning to the first communication mode includes switching to the second communication mode as a main communication means. Returning to the first communication mode further includes executing a ping test to check whether the first communication mode is normal in the background.

Connecting in the wired manner includes, after the connection, simultaneously accessing, by the control unit, the two network blocks during booting.

According to the present disclosure, because the wireless terminal is normally connected to both the P-5G network and the Wi-Fi network (physical layer ready state), when a communication problem occurs in the P-5G network, the immediate switching to the Wi-Fi network can be performed. Thus, the continuity of wireless communication without disconnection may be ensured.

In addition, the real-time communication method can be changed by the metric setting method of the wireless interface in the wireless terminal.

In addition, because the physical layer in which takes a long time to connect to the communication is already provided, a quick communication method switching algorithm is possible in the event of a communication problem.

In addition, by sufficiently checking whether the communication of the P-5G network before switching to the P-5G communication method after a communication problem occurs and performing the switching, it is possible to secure the stability of the communication. In other words, it is possible to secure the stability of the wireless communication by adopting the hysteresis test function.

### BRIEF DESCRIPTION OF THE DRAWINGS

FIG. 1 is a block diagram of a configuration of a network switching system in a redundant environment according to one embodiment of the present disclosure.

FIG. 2 is a block diagram of a detailed configuration of a Private-5G (P-5G) block shown in FIG. 1.

FIG. 3 is a block diagram of a detailed configuration of a Wi-Fi block shown in FIG. 1.

FIG. 4 is a block diagram of a detailed configuration of a wireless connecting device shown in FIG. 1.

FIG. 5 is a block diagram of a detailed configuration of a control unit shown in FIG. 2.

FIG. 6 is a view showing the exterior of the wireless connecting device shown in FIG. 1.

FIG. 7 is a conceptual diagram showing the wireless connecting device shown in FIG. 1 connected to wireless equipment to form a network.

FIG. 8 is a flowchart showing a network switching and network recovering process in a redundant environment according to one embodiment of the present disclosure.

FIG. 9 is a flowchart more specifically showing a ping test process for the network switching process shown in FIG. 8.

FIGS. 10A and 10B are flowcharts more specifically showing the network recovering process shown in FIG. 8.

### DESCRIPTION OF SPECIFIC EMBODIMENTS

The above-described objects, features, and advantages are described below in detail with reference to the accompanying drawings. Those having ordinary skill in the art to which the present disclosure pertains should be able to easily carry out the technical spirit of the present disclosure. In describing the present disclosure, when it is determined that a detailed description of the known technology related to the present disclosure may unnecessarily obscure the gist of the present disclosure, a detailed description thereof has been omitted.

Hereinafter, embodiments according to the present disclosure are described in detail with reference to the accompanying drawings. In the drawings, the same reference numerals are used to denote the same or similar components. When a controller, module, component, device, element, part, unit or the like of the present disclosure is described as having a purpose or performing an operation, function, or the like, the controller, module, component, device, element, part, unit, or the like should be considered herein as being “configured to” meet that purpose or to perform that operation or function. Each controller, module, component, device, element, part, unit, and the like may separately embody or be included with a processor and a memory, such as a non-transitory computer readable media, as part of the apparatus.

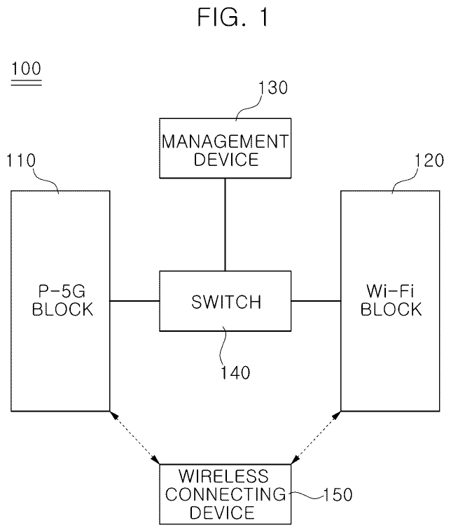

FIG. 1 is a block diagram of a configuration of a network switching system 100 in a redundant environment according to one embodiment of the present disclosure. Referring to FIG. 1, the network switching system 100 may include a Private-5G (P-5G) block 110, a Wi-Fi block 120, a switch 140 that performs switching between the P-5G block 110 and the Wi-Fi block 120, a management device 130 for managing the switch 140, and a wireless connecting device 150 connected to the P-5G block 110 and the Wi-Fi block 120. In an embodiment, the wireless connecting device 150 may be connected to wireless equipment.

The P-5G block (i.e., a first network block) 110 operates similarly to a public 5G network but provides the owner with limited access. Therefore, the P-5G block 110 is used in closed facilities, such as manufacturing plants, ports, and airports.

The Wi-Fi block (i.e., a second network block) 120 performs a function of transmitting data between a device and an access point using wireless radio waves.

The management device 130 performs a function of managing the operation of the switch 140. The P-5G block 110 and/or the Wi-Fi block 120 are monitored to manage operation and access.

The switch 140 performs a function of switching between the P-5G block 110 and the Wi-Fi block 120. In other words, the switch 140 switches communication connection from the Wi-Fi block 120 to the P-5G block 110 according to a command from the management device 130.

The wireless connecting device 150 is installed or connected to wireless equipment to perform a function of communicatively connecting the wireless facility to the P-5G block 110 and/or the Wi-Fi block 120. In particular, the wireless connecting device 150 connects the wireless equipment to the P-5G block 110 as main communication and switches to the Wi-Fi block 120 for communication connection when a failure occurs in the P-5G block 110.

An opposite case is also possible. In other words, the wireless connecting device 150 connects the wireless equipment to the Wi-Fi block 120 as main communication and switches to the P-5G block 110 for communication connection when a failure occurs in the Wi-Fi block 120.

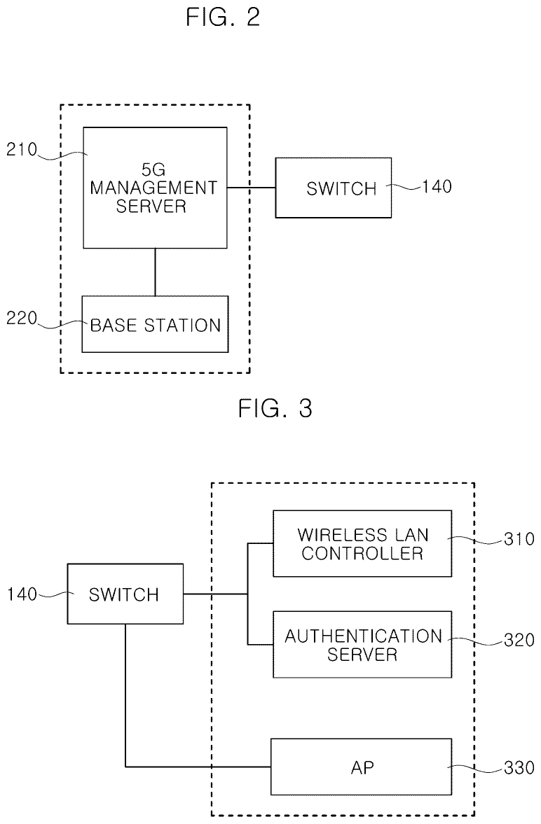

FIG. 2 is a block diagram of a detailed configuration of the P-5G block 110 shown in FIG. 1. Referring to FIG. 2, the P-5G block 110 may include a 5G management server 210, a base station 220, etc. The 5G management server 210 performs a function of managing the P-5G network.

The base station 220 performs a function of performing communication with the wireless connecting device 150 to transmit a signal from the wireless connecting device 150 to the 5G management server 210 or transmitting a signal from the 5G management server 210 to the wireless connecting device 150.

To this end, the base station 220 may comprise a digital unit (DU) for encrypting and decrypting a digital signal and may comprise a radio unit (RU) for converting the digital signal into a radio signal according to a frequency band, etc. The DU comprises a channel card, and the RU comprises a transceiver, a signal converter, an amplifier, a filter, etc.

FIG. 3 is a block diagram of a detailed configuration of the Wi-Fi block 120 shown in FIG. 1. Referring to FIG. 3, the Wi-Fi block 120 includes a wireless LAN controller 310, an authentication server 320, an access point (AP) 330, etc.

The wireless LAN controller 310 performs a function of setting a wireless policy and monitoring and managing the AP 330, which is a wireless LAN-related device. The authentication server 320 performs a security authentication function. In other words, security authentication is performed on wireless equipment connected through the AP 330, and the connection is permitted only to wireless equipment with legitimate authority.

The AP 330 is a network device that connects wired and wireless networks using the Wi-Fi standard and is a device that functions as a wireless hub.

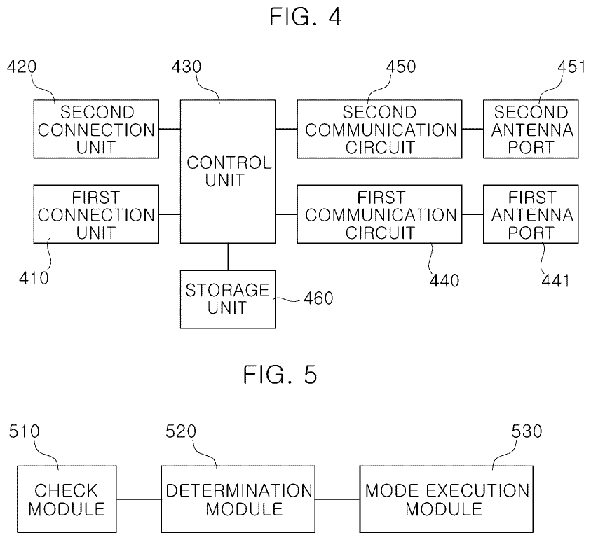

FIG. 4 is a block diagram of a detailed configuration of the wireless connecting device 150 shown in FIG. 1. Referring to FIG. 4, the wireless connecting device may include a first connection unit 410, a second connection unit 420, a control unit 430, a first communication circuit 440, a second communication circuit 450, a first antenna port 441, a second antenna port 451, a storage unit 460, etc.

The first connection unit 410 and the second connection unit 420 are connection ports connected to wireless equipment in a wired manner. Therefore, the wireless equipment and the wireless connecting device 150 are connected through a communication cable via the first connection unit 410 and the second connection unit 420. Although two connection units are shown in FIG. 4, two or more connection units may be configured.

The control unit 430 performs a function of executing a first communication mode in which the wireless equipment is connected to one of the two network blocks 110 and 120 as main communication, checking whether a communication failure occurs during the execution of the first communication mode. The control unit 430 performs, when the communication failure occurs, a function of executing a second communication mode in which wireless equipment 710 is connected to the other of the two network blocks 110 and 120.

The first communication circuit 440 performs a function of supporting a communication mode (i.e., a P-5G mode). In other words, the first communication circuit 440 connects the wireless equipment to the P-5G block 110 corresponding to the first network block. The first communication circuit 440 may include a communication chip, a microprocessor, a communication card, etc. for P-5G. The first antenna port 441 connected to a physical antenna is configured at the first communication circuit 440 side.

The second communication circuit 450 performs a function of supporting a communication mode (i.e., a Wi-Fi mode). In other words, the second communication circuit 450 connects the wireless equipment to the Wi-Fi block 120 corresponding to the second network block. The second communication circuit 450 may include a communication chip, a microprocessor, a communication card, etc. for Wi-Fi. The second communication circuit 450 is connected to the second antenna port 451. The second antenna port 451 connected to the physical antenna is configured at the second communication circuit 450 side.

The storage unit 460 stores a software program, data, etc. that have an algorithm for connecting wireless equipment to one of the Wi-Fi block 120 and the P-5G block 110 as main communication and when a communication failure occurs, connecting the wireless equipment to the other. The storage unit 460 stores data processed by the control unit 430.

FIG. 5 is a block diagram of a detailed configuration of the control unit 430 shown in FIG. 2. Referring to FIG. 5, the control unit 430 may include a check module 510 for calculating a delay time according to a ping test, a determination module 520 for comparing the delay time with a preset threshold time (i.e., a threshold time) and determining whether a communication failure occurs, and a mode execution module 530 for changing main communication and executing a communication mode when it is determined that a failure occurs, etc.

The check module 510 performs a function of conducting a ping test to check whether a communication failure occurs and calculating the delay time accordingly. In other words, the check module 510 sends a ping to check whether a communication state of each of the Wi-Fi block 120 and the P-5G block 110 is normal.

At this time, the destination of this ping is a gateway of each of P-5G and Wi-Fi. In other words, the gateway is the switch 140 as shown in FIGS. 2 and 3.

The determination module 520 performs a function of comparing the delay time with the preset threshold time and determining whether a communication failure occurs according to the result of the comparison. In other words, when the delay time is longer than the threshold time, it may be determined that a delay has occurred due to a communication failure. When the delay time is smaller than or equal to the threshold time, it is determined that a current communication state is normal.

The mode execution module 530 holds the current state or changes the main communication according to the determination of the determination module 520. In other words, when it is determined that no communication failure has occurred, the mode execution module 530 continuously executes the first communication mode in which the wireless equipment is connected to the P-5G block 110 or the Wi-Fi block 120 as the main communication.

In contrast, when it is determined that a communication failure has occurred, the mode execution module 530 changes the main communication and executes the second communication mode in which the wireless equipment is connected to another Wi-Fi block 120 or P-5G block 110 that is not connected in the first communication mode.

For example, when a communication failure occurs in a state of executing the first communication mode in which the wireless equipment is connected to the P-5G block 110 as the main communication in the first communication mode, the second communication mode in which the wireless equipment is connected to the Wi-Fi block 120 is executed.

When a communication failure occurs in a state of executing the first communication mode in which the wireless equipment is connected to the Wi-Fi block 120 as the main communication in the first communication mode, the second communication mode in which the wireless equipment is connected to the P-5G block 110 is executed.

The term “ . . . module” described in FIG. 5 refers to a unit that processes at least one function or operation, which may be implemented as software and/or hardware. In implementing hardware, the hardware can be implemented as an application specific integrated circuit (ASIC) designed to perform the above-described functions, digital signal processing (DSP), a programmable logic device (PLD), a field programmable gate array (FPGA), a processor, a microprocessor, other electronic units, or a combination thereof.

In implementing software, the software may include software composition components (elements), object-oriented software composition components, class composition components and task composition components, processes, functions, attributes, procedures, subroutines, segments of program code, drivers, firmware, microcode, data, databases, data structures, tables, arrays, and variables. The software, the data, and the like may be stored in a memory and executed by a processor. The memory or the processor may adopt various means well known to those having ordinary skill in the art.

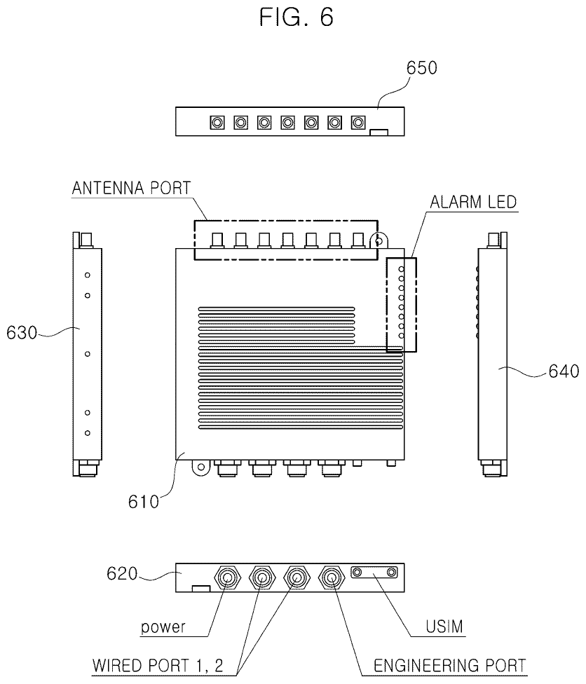

FIG. 6 is a view showing the exterior of the wireless connecting device 150 shown in FIG. 1. FIG. 6 shows a plan view 610, a front view 620, a left side view 630, a right side view 640, and a rear view 650. In the plan view 610, an alarm light emitting diode (LED) indicating a normal or faulty operation of the wireless connecting device 150 is shown.

In the front view 620, a power terminal, wired ports 1 and 2 corresponding to connection units 410 and 420, an engineering port, a universal subscriber identity module (USIM), etc. are shown. In the rear view 650, an antenna port, etc. is shown.

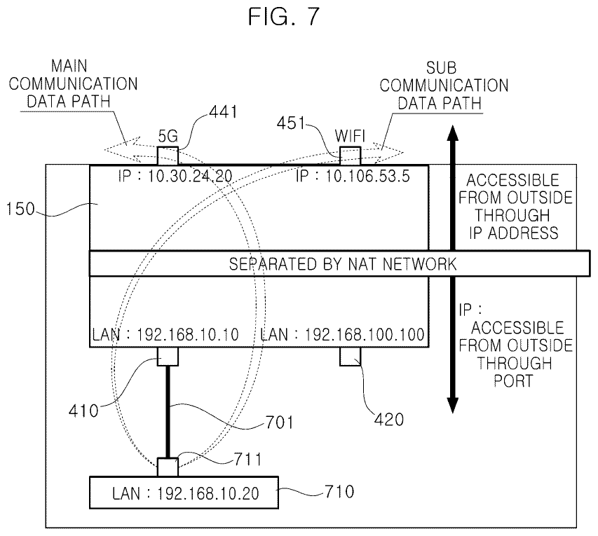

FIG. 7 is a conceptual diagram showing the wireless connecting device 150 shown in FIG. 1 connected to the wireless equipment 710 to form a network. Referring to FIG. 7, a wired port 711 of the wireless equipment 710 is connected to a first connection unit 410 formed on the wireless connecting device 150 via a LAN cable 701. The wireless equipment 710 may be an AGV, an autonomous mobile robot, wireless electronic part inspection equipment, a tablet PC (personal computer), a PDA, etc. Therefore, the wireless equipment may also be connected to the second connection unit 420.

The wireless equipment 710 may access the wireless connecting device 150 from the outside through a port. To this end, a unique LAN Internet protocol address (IP) is set for each of the wireless equipment 710 and the wireless connecting device 150.

The wireless connecting device 150 is connected to the P-5G block 110 through the first antenna port 441 in a wireless manner and forms a main communication data path. Meanwhile, the wireless connecting device 150 is connected to the Wi-Fi block 120 through the second antenna port 451 in a wireless manner and forms a sub communication data path.

Usually, the wireless equipment 710 communicates with the P-5G block 110 using the main communication (5G IP: 10.30.24.30) data path, and when a communication failure occurs in the P-5G block 110, communicates with the Wi-Fi block 120 using the sub communication (Wi-Fi IP: 10.106.53.5) data path. When a wireless equipment IP is changed, checking as to whether the Wi-Fi block 120 has a problem is completed.

Meanwhile, when the communication failure problem that has occurred in the P-5G block 110 is solved, communication is re-performed using the main communication (5G IP: 10.30.24.30) data path. When the wireless equipment IP is changed, checking as to whether the P-5G block 110 has a problem is completed.

In addition, the LAN IP and the 5G IP/Wi-Fi IP are separated by a network address translation (NAT) network in the wireless connecting device 150. The LAN IP is switched to the 5G IP and/or the Wi-Fi IP using the NAT network.

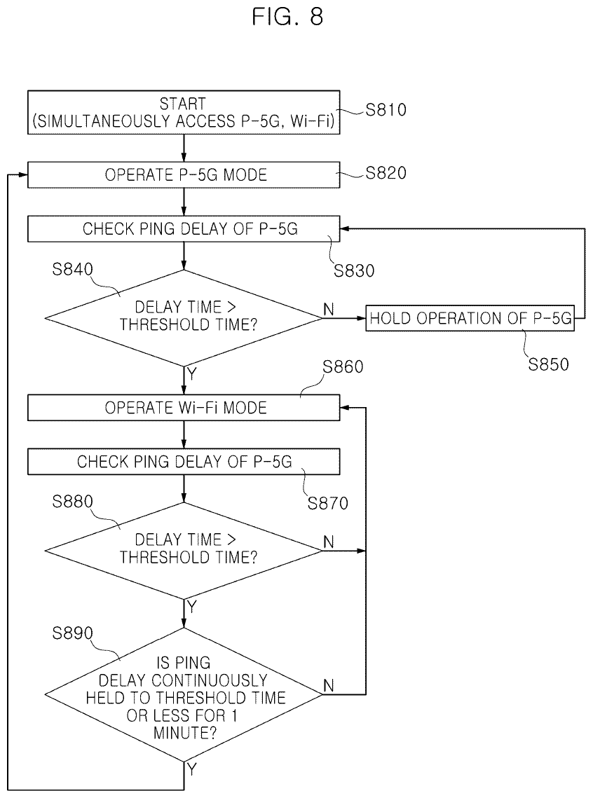

FIG. 8 is a flowchart showing a network switching and network recovering process in a redundant environment according to one embodiment of the present disclosure. Referring to FIG. 8, after the wireless connecting device 150 is booted after being connected to the wireless equipment 710, the wireless equipment 710 is simultaneously connected to the P-5G block 110 and the Wi-Fi block 120 (operation S810). The wireless connecting device 150 is used in an environment in which both Wi-Fi and P-5G infrastructures are installed.

Then, the wireless connecting device 150 operates in the P-5G mode (i.e., the first communication mode) in which the wireless equipment 710 is connected to the P-5G block 110 as the main communication (operation S820).

Then, the wireless connecting device 150 calculates a delay time (i.e., a first delay time) through a ping test (operation S830).

Then, the wireless connecting device 150 checks whether the first delay time (delay time) is longer than a threshold time (operation S840). In other words, when the first delay time is longer than the threshold time, it may be determined that a communication failure has occurred on the network.

As the result of the checking, when the first delay time is shorter than or equal to the threshold time in operation S840 (N in S840), the operation is held in the P-5G mode (i.e., the first communication mode) (operation S850). Then, operations S830 and S840 are re-performed.

In contrast, when the first delay time is longer than the threshold time in operation S840 (Y in S840), the wireless connecting device 150 operates in the Wi-Fi mode (i.e., the second communication mode) in which the wireless equipment is connected to the Wi-Fi block 120 (operation S860).

Then, the wireless connecting device 150 re-performs a ping test toward the P-5G block 110 to calculate a delay time (i.e., a second delay time) (operation S870).

Then, the wireless connecting device 150 checks whether the second delay time (delay time) is longer than the threshold time (operation S880).

As the result of the checking, when the second delay time is shorter than or equal to the threshold time in operation S880 (N in S880), operations S860 to S880 are re-performed.

In contrast, as the result of the checking, when the second delay time is longer than the threshold time in operation S880 (Y in S880), whether a non-recurrence condition, which defines that a communication failure does not recur, is satisfied is checked (operation S890). Here, the non-recurrence condition is a condition in which the delay time is continuously shorter than or equal to the threshold time for a specific time (e.g., about 1 minute). The continuation may be set to about 3 times in consideration of an execution cycle of the ping test.

As the result of the checking, when the non-recurrence condition is not satisfied in operation S890 (N in S890), operations S860 to S890 are re-performed.

In contrast, when the non-recurrence condition is satisfied in operation S890 (Y in S890), the wireless connecting device 150 returns to the P-5G mode (i.e., the first communication mode) in which the wireless equipment 710 is connected to the P-5G block 110 as the main communication.

In FIG. 8, a case in which wireless equipment 810 is connected to the P-5G block 110 as main communication is described, but a case in which the wireless equipment 810 is connected to the Wi-Fi block 120 as the main communication may be described similarly. In this case, the operation is performed primarily in the Wi-Fi mode, and the operation is performed secondarily in the P-5G mode. Whether to use the P-5G block 110 or the Wi-Fi block 120 as the main communication may be set and stored in advance by programming in the wireless connecting device 150.

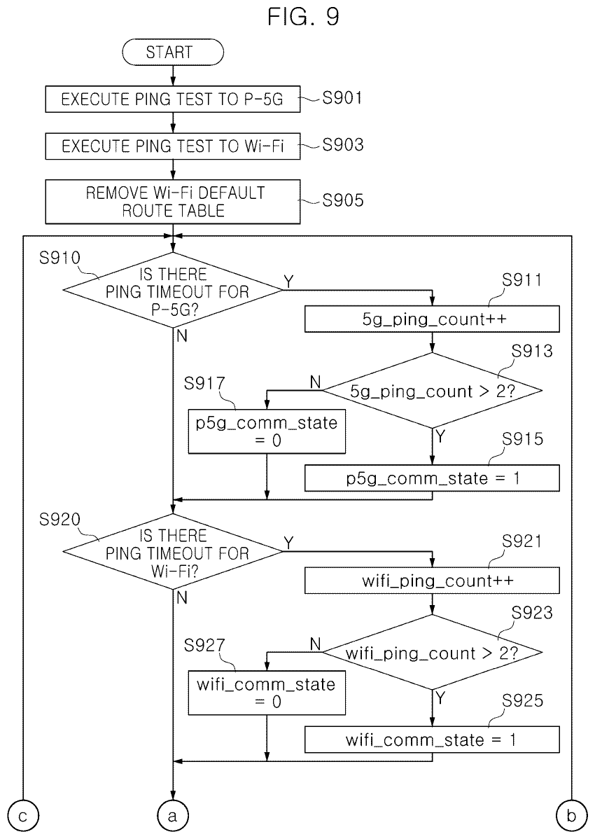

FIG. 9 is a flowchart more specifically showing the network switching process shown in FIG. 8. In other words, FIG. 9 specifically shows the process of performing a ping test on the P-5G block 110 and the Wi-Fi block 120. Referring to FIG. 9, after the wireless connecting device 150 is booted normally, a ping test is performed on the P-5G block 110 and the Wi-Fi block 120 sides, and a Wi-Fi default route table is removed (operations S901, S903, S905). In other words, whether normal communication is possible through the gateway of the P-5G block 110 and the Wi-Fi block 120 is checked.

Then, whether there is a ping timeout for the P-5G block 110 is checked, and when there is the timeout, a 5G ping count 5g ping_count is increased by “+1,” and based on whether a value of the 5G ping count 5g_ping_count (i.e., the delay time) is greater than 2 (i.e., whether a delay of 3 seconds occurs), a current P-5G communication state p5g_comm_state becomes an unsafe state (1) or a normal state (0) (operations S910 to S915). In other words, whether normal communication is possible through a P-5G interface is checked. The above check may be performed every 1 second cycle.

In other words, when the delay of 3 seconds is checked through the P-5G interface, communication is immediately switched to a Wi-Fi interface. The communication interface switching is performed immediately without delay.

Then, whether there is a ping timeout for the Wi-Fi block 120 is checked, and when there is the timeout, a Wi-Fi ping count wifi_ping_count is increased by “+1,” and a current Wi-Fi communication state wifi_comm_state is an unstable state (1) or a normal state (0) based on whether a value of the Wi-Fi ping count wifi_ping_count is greater than 2 (operations S910 to S915).

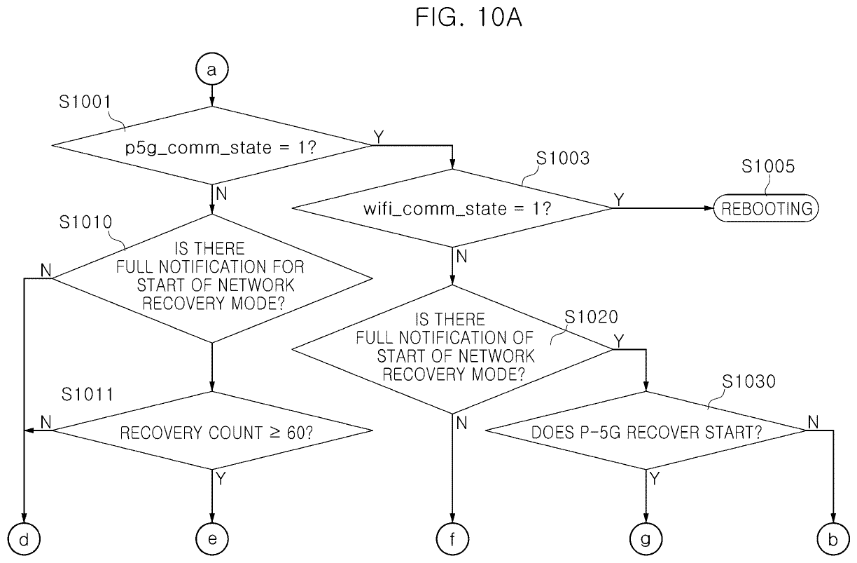

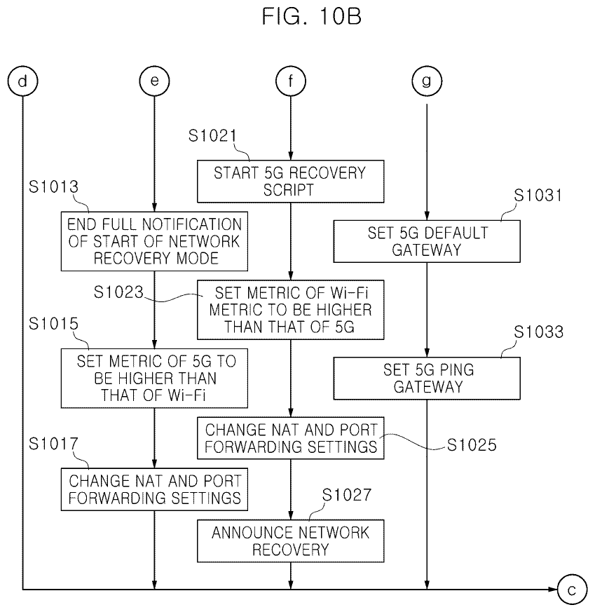

FIGS. 10A and 10B are flowcharts more specifically showing the network recovering process shown in FIG. 8. FIGS. 10A and 10B specifically show the network recovering process after the operations executed in FIG. 9. Referring to FIGS. 10A and 10B, whether the current P-5G communication state p5g_comm_state is an unsafe state (1) or a normal state (0) is checked, and when it is a normal state, whether there is a full notification for the start of a network recovery mode is checked and whether a recovery count is a reference value (e.g., 60=1 minute) or more is checked, and when the recovery count is the reference value or more, a full notification for the start of the network recovery mode is ended, a metric of 5G is set higher than that of Wi-Fi, and NAT and port forwarding settings are changed (operations S1010 to S1017). In other words, when normal communication is checked for 1 minute through the P-5G interface without any abnormality, switching back to P-5G communication is performed. Because the wireless connecting device 150 has both the Wi-Fi communication interface and the P-5G communication interface, it is necessary to determine which interface the wireless connecting device 150 communicates with for normal communication. This is done by setting the metric, the metric setting may be specified using a number, and the lower the number, the higher the priority. In this case, the NAT and port forwarding settings are restored to the initial P-5G settings. This is a process of re-setting pieces of system setting information, which are required while performing the communication through Wi-Fi, to be used after switching to the P-5G mode. In other words, the NAT and port forwarding settings, which are system setting information, are changed.

Meanwhile, when the current P-5G communication state p5g_comm_state is an unstable state in operation S1001, whether the current Wi-Fi communication state wifi_comm_state is an unstable state or a normal state is checked, and when it is the unstable state, the wireless connecting device 150 is rebooted (operations S1003, S1005).

In contrast, when the Wi-Fi communication state wifi_comm_state is the normal state in operation S1003, whether there is the full notification of the start of the network recovery mode is checked, and when there is the full notification, a 5G recovery script starts, a metric of Wi-Fi is set higher than that of 5G, the NAT and port forwarding settings are changed, and the fact that the network recovery mode is now operated due to the occurrence of the failure of the P-5G is announced (operations S1020 to S1027).

In this case, the metric setting is set so that the communication connecting device may actually operate in the Wi-Fi mode by increasing the priority of the Wi-Fi mode. In addition, a process of re-setting the pieces of the system setting information, which are required while operating in the P-5G mode, to be used after switching to the Wi-Fi mode is performed. In other words, the NAT and port forwarding settings are changed. The recovery script means an action of registering or canceling the communication circuits 440 and 450 to the base station 220.

Meanwhile, when there is the full notification of the start of the network recovery mode in operation S1020, whether P-5G recovery starts is checked, and when it starts, a 5G default gateway is set and a 5G ping gateway is set (operations S1030, S1031, S1033). When abnormality occurs in the P-5G mode, after switching to the Wi-Fi mode as a main communication means, whether the P-5G mode is normal in the background is checked through the ping test. In this case, to check whether the P-5G mode is normal while sending a ping, a process of setting a gateway for the P-5G communication interface is required. In addition, when operation S1031 is ended in connection with such a gateway setting process, a ping is actually sent to check whether the P-5G communication has been normally recovered (operation S1033).

There is no ping delay problem in a situation in which P-5G and Wi-Fi communication are mutually switched. In addition, when TCP communication is in progress at the time of switching between P-5G and Wi-Fi, the corresponding access is disconnected. In other words, the TCP communication is disconnected due to physical interface switching.

In addition, the operations of the method or algorithm described in relation to the embodiments disclosed herein may be implemented in the form of program commands that may be executed through various computer devices, such as a microprocessor, a processor, and a CPU and stored in a computer-readable medium. The computer-readable medium may include program (command) codes, data files, data structures, etc. alone or in combination.

What is claimed is:

1. A wireless connecting device for switching a network in a redundant environment, the wireless connecting device comprising:
a connection unit communicatively connected to wireless equipment in a wired manner;
a control unit configured to
execute a first communication mode as main communication, wherein in the first communication mode, the wireless equipment is connected to one of two network blocks, and wherein the two network blocks are in the redundant environment,
check whether a communication failure occurs during the execution of the first communication mode, and
when the communication failure occurs, execute a second communication mode, wherein in the second communication mode, the wireless equipment is connected to the other of the two network blocks; and
a communication circuit configured to connect the wireless equipment to one of the two network blocks according to the first communication mode or the second communication mode.

2. The wireless connecting device of claim 1, wherein the control unit includes:
a check module configured to calculate a first delay time according to a ping test toward the two network blocks;
a determination module configured to compare the first delay time with a preset threshold time and determine whether a communication failure occurs according to a result of the comparison; and
a mode execution module configured to execute the second communication mode when it is determined that the communication failure has occurred according to a result of the determination.

3. The wireless connecting device of claim 2, wherein the mode execution module is further configured to hold the execution of the first communication mode when it is determined that the communication failure has not occurred according to the result of the determination.

4. The wireless connecting device of claim 2, wherein, after the second communication mode is executed, the check module is further configured to calculate a second delay time according to the ping test toward one of the two network blocks,
wherein the determination module is further configured to:
compare the second delay time with the preset threshold time;
determine whether the communication failure occurs according to the result of the comparison; and
when it is determined that the communication failure has occurred according to the result of the determination, determine whether a non-recurrence condition that defines that the communication failure does not recur is satisfied, and
wherein, when the non-recurrence condition is satisfied, the mode execution module is further configured to return to the first communication mode.

5. The wireless connecting device of claim 4, wherein the non-recurrence condition is a condition in which the second delay time is continuously shorter than or equal to the preset threshold time for a specific time.

6. The wireless connecting device of claim 4, wherein, when the non-recurrence condition is not satisfied, the mode execution module is further configured to hold the execution of the second communication mode.

7. The wireless connecting device of claim 1, wherein the control unit is further configured to simultaneously access the two network blocks during booting.

8. The wireless connecting device of claim 1, wherein the two network blocks are heterogeneous communication networks.

9. The wireless connecting device of claim 8, wherein the heterogeneous communication networks include a wireless fidelity (Wi-Fi) communication network and a Private-5G (P-5G) communication network.

10. A method of switching a network in a redundant environment, the method comprising:
communicatively connecting wireless equipment to a connection unit in a wired manner;
executing, by a control unit, a first communication mode as main communication, wherein in the first communication mode, the wireless equipment is connected to one of two network blocks, and wherein the two network blocks are in the redundant environment;
checking, by the control unit, whether a communication failure occurs during the execution of the first communication mode; and
when the communication failure occurs, executing, by the control unit, a second communication mode, wherein in the second communication mode, the wireless equipment is connected to the other of the two network blocks; and
connecting, by a communication circuit, the wireless equipment to one of the two network blocks according to the first communication mode or the second communication mode.

11. The method of claim 10, wherein executing the second communication mode includes:
calculating, by a check module, a first delay time according to a ping test toward the two network blocks;
comparing, by a determination module, the first delay time with a preset threshold time;
determining, by the determination module, whether a communication failure occurs according to a result of the comparison; and
executing, by a mode execution module, rebooting when it is determined that the communication failure has occurred according to a result of the determination.

12. The method of claim 11, wherein executing the second communication mode includes holding, by the mode execution module, the execution of the first communication mode when it is determined that the communication failure has not occurred according to the result of the determination.

13. The method of claim 11, wherein executing the second communication mode includes:
after the second communication mode is executed, calculating, by the check module, a second delay time according to the ping test toward one of the two network blocks;
comparing, by the determination module, the second delay time with the preset threshold time;
determining, by the determination module, whether the communication failure occurs according to the result of the comparison; and
when it is determined that the communication failure has occurred according to the result of the determination, determining, by the determination module, whether a non-recurrence condition that defines that the communication failure does not recur is satisfied; and
when the non-recurrence condition is satisfied, returning, by the mode execution module, to the first communication mode.

14. The method of claim 13, wherein the non-recurrence condition includes a condition in which the second delay time is continuously shorter than or equal to the preset threshold time for a specific time.

15. The method of claim 13, wherein returning to the first communication mode includes, when the non-recurrence condition is not satisfied, holding, by the mode execution module, the execution of the second communication mode.

16. The method of claim 15, wherein returning to the first communication mode includes:
setting a metric that specifies the first communication mode to have a higher priority than the second communication mode; and
re-setting system settings required while operating in the second communication mode to be used after switching to the second communication mode.

17. The method of claim 15, wherein returning to the first communication mode includes:
switching to the second communication mode as a main communication means; and
executing a ping test to check whether the first communication mode is normal in background.

18. The method of claim 10, wherein connecting in the wired manner includes, after the connection, simultaneously accessing, by the control unit, the two network blocks during booting.
